(19) United States
(12) Patent Application Publication
(10) Pub. No.: US 2018/0194416 A1
(43) Pub. Date: Jul. 12, 2018

(54) VEHICLE ASSEMBLY FACILITY

(71) Applicant: MAGNA STEYR Fahrzeugtechnik AG & Co KG, Graz (AT)

(72) Inventor: Guenter Wolfsberger, Lieboch (AT)

(21) Appl. No.: 15/837,285

(22) Filed: Dec. 11, 2017

(30) Foreign Application Priority Data
Jan. 9, 2017 (EP) 17150639.7

(51) Int. Cl. B62D 65/02

(52) U.S. Cl. CPC B62D 65/022

(57) ABSTRACT

A vehicle assembly facility and system that includes a conveyor track having a three-dimensional helical configured to transport components of a vehicle for complete assembly of a vehicle.

### CROSS-REFERENCE TO RELATED APPLICATIONS

The present application claims priority under 35 U.S.C. § 119 to European Patent Application No. EP 17150639.7 (filed on Jan. 9, 2017), which is hereby incorporated by reference in its complete entirety.

### TECHNICAL FIELD

Embodiments relate to a vehicle assembly facility comprising a conveyor track, the conveyor track being configured to transport part-vehicles and stations for completing the part-vehicles are arranged along the conveyor track.

### BACKGROUND

It has already been known for some time that the productivity in the assembly of vehicles, in particular, of motor vehicles, may be considerably increased by the use of production lines and similar part-vehicle conveyor tracks. In this instance, individual incomplete vehicles are moved using the conveyor tracks from one station to the next and within the station components or modules are secured to the part-vehicle which has already been assembled.

For example, German Patent Publication No. DE 31 46 807 A1 discloses such a conveyor system which uses overhead conveyors on which a motor vehicle bodywork may be suspended for transport.

A similar overhead belt system is also known from U.S. Patent Publication No. US 2003/000413 A1.

A conveyor system in which a mobile platform is provided for each motor vehicle is known, for example, from German Patent Publication No. DE 10 2005 062 691 A1.

In known vehicle assembly facilities for vehicles which comprise conveyor system for the vehicles, however, it is disadvantageous that long paths for the incoming and outgoing transport of the components which are intended to be assembled have to be travelled and therefore the assembly of the vehicles is costly.

### SUMMARY

In accordance with embodiments, a vehicle assembly facility is provided which enables cost-effective assembly of vehicles, in particular, via short paths for the components which are intended to be used.

In accordance with embodiments, a vehicle assembly facility may comprise a conveyer track having a three-dimensional helical shape which configured to transport part-vehicles and stations to complete the part-vehicles arranged along the conveyor track.

In accordance with embodiments, a conveyor track for transporting part-vehicles during the assembly of the vehicle is constructed as a three-dimensional (e.g., x, y, and z planes) helix, and consequently, the vertical dimension is advantageously used in order to shorten the paths to the individual work stations. As a result of the construction in the form of a helix, for example, it is possible not only for stations to be adjacent to each other in the surface of the assembly hall, but also for them to be located vertically above and below each other, and consequently a simpler, shorter transport of components from one station to the next is enabled.

In accordance with embodiments, an advantage of the helical shape is that the entire external logistics, that is to say, the delivery of individual components or already pre-assembled part-assemblies may dock from the exterior directly onto the vehicle assembly facility, for example, via containers or lorries, such that a particularly efficient use of the space provided is achieved and a very high frequency of the delivery of components and precise delivery to the specific production sequence is possible. It is also advantageous that only minimal floor space is required to carry out the entire vehicle production.

In accordance with embodiments, the conveyor track may in particular be constructed in a similar manner to a conveyor belt such that the part-vehicles are carried on the conveyor track and/or are also constructed as a suspended track so that the part-vehicles are suspended on the conveyor track.

In accordance with embodiments, the conveyor track may in particular be composed of steel.

In accordance with embodiments, the vehicle assembly facility may be used for the production of entire vehicles, i.e., for complete assembly up to the completion of the vehicles. It may also be configured, however, for the production of individual components of vehicles.

In accordance with embodiments, the conveyor track comprises at least one, or at least two, or at least three, or at least four, complete helical windings/planes which may be arranged vertically one above the other, and may be reduced or expanded in a modular manner.

In accordance with embodiments, the conveyor track comprises at least as many helical windings/planes as are required for the assembly of the vehicle component or the entire vehicle. Consequently, the assembly requirements are taken into account in a flexible manner. The components of the helix may all be identical.

In accordance with embodiments, an entire helix may comprise a plurality of elements or helical windings/planes which may be arranged one spatially above the other and connected, assembled, screwed, welded, etc., and which at the end produce a helical tower having a corresponding height and which corresponds to the complexity of the respective assembly operations.

In accordance with embodiments, a pre-assembled element could, for example, correspond to a helical winding or helical plane or also represent only a portion of a helical winding. The conveyor track may therefore be constructed as a modular multi-component system whose elements are constructed for assembly, mechanically such as, for example, screwing together, and/or by welding together.

In accordance with embodiments, the conveyor track may have at least one, but also two or more vehicle lanes beside each other so that a vehicle in one lane may “overtake” another vehicle in another lane. For example, an assembly station may thereby be omitted or duplicated.

In accordance with embodiments, the conveyor track is configured to transport the vehicles along the helix from top to bottom. By using gravitational force, consequently, less energy may also be required to move the vehicles.

In accordance with embodiments, at the upper input of the helical conveyor track, a device may be arranged to transfer, preferably already painted bodyworks and/or drive trains of vehicles to the conveyor track. These bodyworks and/or drive trains may act as a base in order to secure additional vehicle components or modules thereto.

In accordance with embodiments, laterally beside the conveyor track, that is to say, at the outer side or the inner side of the helix, at least one hoist or a lifting device, for example, at least one lifting table, may be arranged as a supply unit for components which are intended to be installed. Such a table or liftable carrier component thereof may be lifted to a plurality, at least two, or all of the helical planes of the conveyor track, and particularly, to the stations located there in order to complete the part-vehicles.

In accordance with embodiments, a plurality of such hoists or lifting devices, for example, lifting tables, are arranged on the conveyor track, such as, for example, radially and at different heights, so that a plurality of stations which are distributed peripherally and in the planes may be reached for the assembly of components via the lifting tables. At least two stations, or at least three stations, may be arranged vertically spatially below each other in approximately the same horizontal position.

In accordance with embodiments, the hoists, lifting devices, or lifting tables, may be constructed to raise and lower containers. Components for assembly may thereby be removed directly from delivery containers. Delivery paths and delivery vehicles, such as fork lift trucks, may consequently be saved.

In accordance with embodiments, the lifting tables may be, in particular, constructed as scissor type lifting tables or as a lifting platform/lift for conveying containers. The hoists or lifting devices may also be constructed as container lifts.

In accordance with embodiments, it is also possible for the hoists or lifting devices to lift only the container or containers and to be directly connected thereto so that a lifting table or a lifting platform as a carrier component which is separate from the container may be dispensed with.

In accordance with embodiments, the lifting device may be mounted on a floor, but also in an upper region, for example, in the region of a carrier structure close to a hall ceiling.

In accordance with embodiments, there may be, for example, provided supply units for submodules at the assembly stations which transport completed submodules from sub-module assembly work locations to the conveyor track.

In accordance with embodiments, the individual stations, components, in particular, submodules, may be mounted on the part-vehicle.

In accordance with embodiments, at the lower output of the conveyor track, a station for end testing the vehicles may be arranged, a so-called “End-of-Line-Testing,” and subsequently a travel track for driving away the completely assembled vehicles or direct loading onto rail vehicles or roadworthy transport devices.

In accordance with embodiments, the region around the centre axis of the conveyor track or in the middle of the conveyor track, in at least one, or in a plurality of helical planes, at least one of the following may be accommodated in order to use the space at the geometric centre of the helix: an administration space (in particular, having at least one desk), and/or at least one social space, and/or at least one sanitary space, and/or at least one space for IT or an IT system, and/or distributors for data lines, and/or date lines, and/or electrical lines and distributors.

In accordance with embodiments, is also possible for the vehicle assembly facility to have beside each other or one spatially above the other at least two helical conveyor tracks which may be coupled to each other, but which may also act independently of each other. In particular, when two helixes are arranged one spatially above the other, the coupling may comprise a mechanical connection of the conveyor tracks. Particularly when the conveyor tracks are arranged beside each other, the coupling may, for example, also be carried out via common connecting work stations.

### DRAWINGS

Embodiments will be illustrated by way of example in the drawings and explained in the description below.

FIG. 1 illustrates a three-dimensional schematic illustration of a vehicle assembly, in accordance with embodiments.

### DESCRIPTION

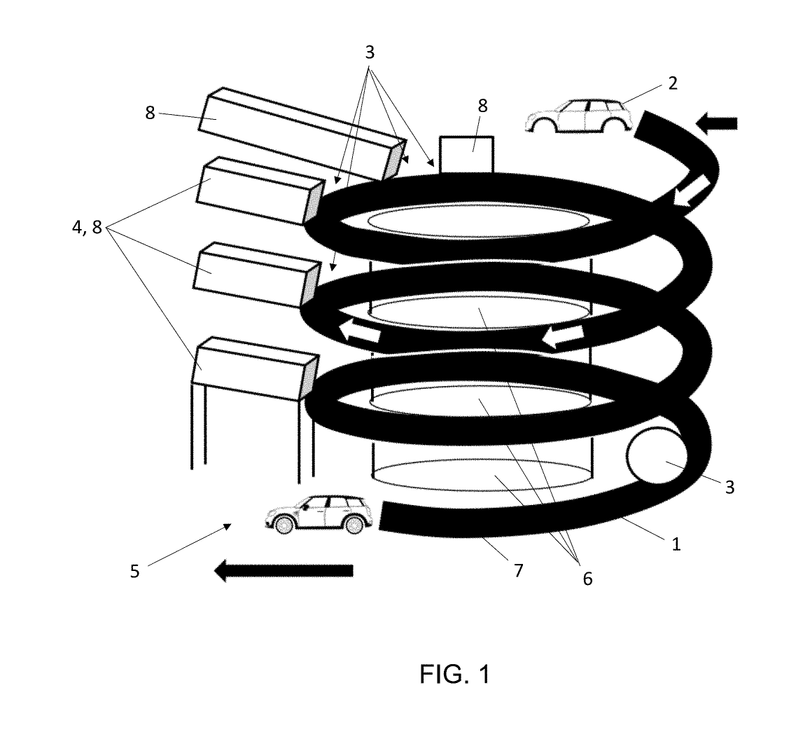

FIG. 1 illustrates a vehicle assembly facility, in accordance with embodiments, having a conveyor track 1 configured to transport part-vehicles or vehicle shell 2, and stations 3 for completing the vehicle shell 2 as a complete vehicle are arranged along the conveyor track 1. In accordance with embodiments, the conveyor track 1 has a three-dimensional helical shape or configuration.

The conveyor track 1 comprises three and a half helical planes, that is to say, three complete helical planes, and is constructed in such a manner that a vehicle shell 2 may be transported along the conveyor track 1 from top to bottom along the helix in the direction indicated by the arrows. At the uppermost level indicated in the region of the uppermost arrow which marks the input of the conveyor track, the input of the conveyor track 1, a device (not illustrated) may be arranged to transfer already-painted bodyworks 2 and drive trains (not illustrated) of vehicles to the conveyor track 1.

Whilst the vehicle shells 2 are transported on the conveyor track 1 from top to bottom, they reach the next station from a station 3 in which components are added to the vehicle shell 2. A plurality of stations 3 may be arranged in a helical plane as illustrated in the uppermost plane and stations 3 may be arranged in a plurality or in all of the helical planes of the conveyor track 1. Stations 3 may be located vertically spatially above and spatially below one another in different helical planes.

At the laterally outer side beside the conveyor track 1, there is arranged a joist or a lifting device, such as, for example, a lifting table 4, whose liftable carrier component, in particular, a table or other platform or directly liftable container, may be lifted to all the helical planes of the conveyor track 1, i.e., to stations 3 for completing assembly of a vehicle by adding various components to the vehicle shell 2.

As illustrated in FIG. 1, three possible positions of the container or table of a lifting table are provided. The lifting table 4 is, for example, a scissor type lifting table, may lift containers with fitted components directly into the stations 3 in order to provide vehicle components for assembly of the vehicle. It is naturally also possible for a plurality of hoists or lifting devices, in particular, lifting tables 4, to be used, and also for other supply units 8 for the stations 3 which may not be moved between the planes to be provided.

At the lower output of the conveyor track 1, an end test station 7 for final control of the vehicles produced and subsequently a travel track 5 for driving away the completely assembled vehicles is constructed and, for example, may be formed by a region of the floor of the assembly hall provided therefor and/or directly acts on a rail vehicle or operates a roadworthy transport means.

About the centre axis of the conveyor track 1, in all the helical planes, an administration space 6, for example, at least one of a screen work place, and/or an office, and/or a server room, may be arranged, respectively.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

### LIST OF REFERENCE SYMBOLS

1 Conveyor track

2 Vehicle shell

3 Station

4 Lifting table

5 Travel track

6 Administration space

7 End test station

8 Supply unit

What is claimed is:

1. A vehicle assembly apparatus, comprising:
a conveyor track configured to transport vehicle shells, the conveyor track having a three-dimensional helical configuration; and
vehicle stations for completing assembly of a vehicle arranged along the conveyor track.

2. The vehicle assembly apparatus of claim 1, wherein the conveyor track comprises at least two helical planes.

3. The vehicle assembly apparatus of claim 1, wherein the conveyor track comprises at least three helical planes.

4. The vehicle assembly apparatus of claim 1, wherein the conveyor track comprises at least four helical planes.

5. The vehicle assembly apparatus of claim 1, wherein the conveyor track comprises a modular multi-component system to permit composed of a plurality of individual helical planes that are connected to each other.

6. The vehicle assembly apparatus of claim 1, wherein the conveyor track comprises at least two vehicle lanes arranged laterally beside each other.

7. The vehicle assembly apparatus of claim 1, wherein the conveyor track is configured to permit assembly of the vehicle sequentially from a top of the three-dimensional helical configuration to a bottom of the three-dimensional helical configuration.

8. The vehicle assembly apparatus of claim 1, further comprising a transfer device arranged at an entry level at an uppermost region of the conveyor track, and which is configured to transfer components of the vehicles to the conveyor track.

9. The vehicle assembly apparatus of claim 8, wherein the components comprises bodyworks and/or drive trains.

10. The vehicle assembly apparatus of claim 1, further comprising at least one lifting device arranged laterally beside the conveyor track, and which is configured for movement between a plurality of helical planes of the conveyor track in order to complete assembly of the vehicle.

11. The vehicle assembly apparatus of claim 1, further comprising at least one lifting table arranged laterally beside the conveyor track, and which is configured for movement between a plurality of helical planes of the conveyor track to complete assembly of the vehicle.

12. The vehicle assembly apparatus of claim 1, further comprising a travel track arranged at a lowermost output of the conveyor track, and which is configured to permit completely assembled vehicles to move from the vehicle assembly apparatus.

13. The vehicle assembly apparatus of claim 1, further comprising at least one of an administration space, and/or an IT system, and/or data lines, and/or electrical lines, and/or electrical distributors arranged at a space of a central axis of the conveyor track.

14. The vehicle assembly apparatus of claim 1, wherein the at least one of an administration space, and/or an IT system, and/or data lines, and/or electrical lines, and/or electrical distributors is arranged in at least one helical plane.

15. A vehicle assembly system, comprising:
a vehicle assembly apparatus that includes at least two conveyor tracks coupled to each other and respectively configured to transport vehicle shells, the at least two conveyor tracks having a three-dimensional helical configuration; and
vehicle stations for completing assembly of a vehicle arranged along the conveyor track,
wherein the at least two conveyor tracks are spatially arranged laterally beside each other.

16. A vehicle assembly system, comprising:
a vehicle assembly apparatus that includes at least two conveyor tracks coupled to each other and respectively configured to transport vehicle shells, the at least two conveyor tracks having a three-dimensional helical configuration; and
vehicle stations for completing assembly of a vehicle arranged along the conveyor track,
wherein the at least two conveyor tracks are spatially arranged one above the other.
